(19) United States
(12) Patent Application Publication
(10) Pub. No.: US 2014/0324671 A1
(43) Pub. Date: Oct. 30, 2014

(54) Cross Border Competencies Tool

(71) Applicant: BANK OF AMERICA CORPORATION, Charlotte, NC (US)

(72) Inventors: Kevin Malvey, Charlotte, NC (US); George S. Carey, Cleveland Heights, OH (US); Molly Oxford, Mesquite, TX (US); Fani Davidson, Chicago, IL (US); Anthony Kell, Fort Worth, TX (US)

(73) Assignee: Bank of America Corporation, Charlotte, NC (US)

(21) Appl. No.: 13/874,094

(22) Filed: Apr. 30, 2013

(51) Int. Cl. G06Q 40/00

(52) U.S. Cl. CPC G06Q 40/025
USPC 705/38

(57) ABSTRACT

According to one embodiment, an apparatus may comprise a memory, a network interface, and a processor communicatively coupled to the memory and the network interface. The memory may store contact information associated with a plurality of lenders. The network interface may receive a request for a loan, wherein a portion of the loan is to be funded by a first lender, and receive a second request indicating a second lender selected from the plurality of lenders. The processor may determine an offer for a second portion of the loan to be funded by the second lender. The network interface may further communicate the offer based at least in part upon the contact information associated with the second lender. The second portion may not funded by the first lender.

### TECHNICAL FIELD

This disclosure relates generally to a tool for enhancing competency of foreign regulations.

### BACKGROUND

As the world becomes increasingly digital and interconnected, regulation of foreign transactions and services grows more complex and intricate. When a client requests a merchant to provide a good or service in a foreign country, the merchant should know the regulations of that country that pertain to the requested good or service. However, inexperienced merchants may not know the relevant regulations, which may cause the transaction to be hindered. Furthermore, the merchant may not understand the steps involved in providing the good or service to the client, which may further hinder the transaction.

### SUMMARY OF THE DISCLOSURE

According to one embodiment, an apparatus may comprise a memory, a network interface, and a processor communicatively coupled to the memory and the network interface. The memory may store contact information associated with a plurality of lenders. The network interface may receive a request for a loan, wherein a portion of the loan is to be funded by a first lender, and receive a second request indicating a second lender selected from the plurality of lenders. The processor may determine an offer for a second portion of the loan to be funded by the second lender. The network interface may further communicate the offer based at least in part upon the contact information associated with the second lender. The second portion may not funded by the first lender.

According to another embodiment, a method may begin by storing contact information associated with a plurality of lenders, and receiving a request for a loan, wherein a portion of the loan is to be funded by a first lender. The method may continue by receiving a second request indicating a second lender selected from the plurality of lenders, and determining an offer for a second portion of the loan to be funded by the second lender. The method may conclude by communicating the offer based at least in part upon the contact information associated with the second lender. The second portion may not funded by the first lender.

According to another embodiment, a system may comprise a storage element, a communication element, and a processing element communicatively coupled to the storage element and communication element. The storage element may store contact information associated with a plurality of lenders. The communication element may receive a request for a loan, wherein a portion of the loan is to be funded by a first lender, and receive a second request indicating a second lender selected from the plurality of lenders. The processing element may determine an offer for a second portion of the loan to be funded by the second lender. The communication element may further communicate the offer based at least in part upon the contact information associated with the second lender. The second portion may not funded by the first lender.

Certain embodiments may provide one or more technical advantages. For example, an embodiment may reduce network traffic associated with identifying and making offers to other lenders. As another example, an embodiment may improve network efficiency by reducing the amount of network traffic associated with handling and/or resolving delays. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a system implementing a cross border competencies tool;

FIG. 2 illustrates the system of FIG. 1 managing subscriptions;

FIG. 3 is a flowchart illustrating a method for managing subscriptions using the system of FIG. 1;

FIG. 4 illustrates the system of FIG. 1 predicting information associated with a loan;

FIG. 5 is a flowchart illustrating a method for predicting information associated with a loan using the system of FIG. 1;

FIG. 6 illustrates the system of FIG. 1 determining an offer;

FIG. 7 is a flowchart illustrating a method for determining offers using the system of FIG. 1;

FIG. 8 illustrates the system of FIG. 1 determining an order of operation;

FIG. 9 is a flowchart illustrating a method for determining orders of operation using the system of FIG. 1;

FIG. 10 illustrates the system of FIG. 1 modifying a template;

FIG. 11 is a flowchart illustrating a method for modifying templates using the system of FIG. 1;

FIG. 12 illustrates the system of FIG. 1 determining an offer;

FIG. 13 is a flowchart illustrating a method for determining offers using the system of FIG. 1.

### DETAILED DESCRIPTION

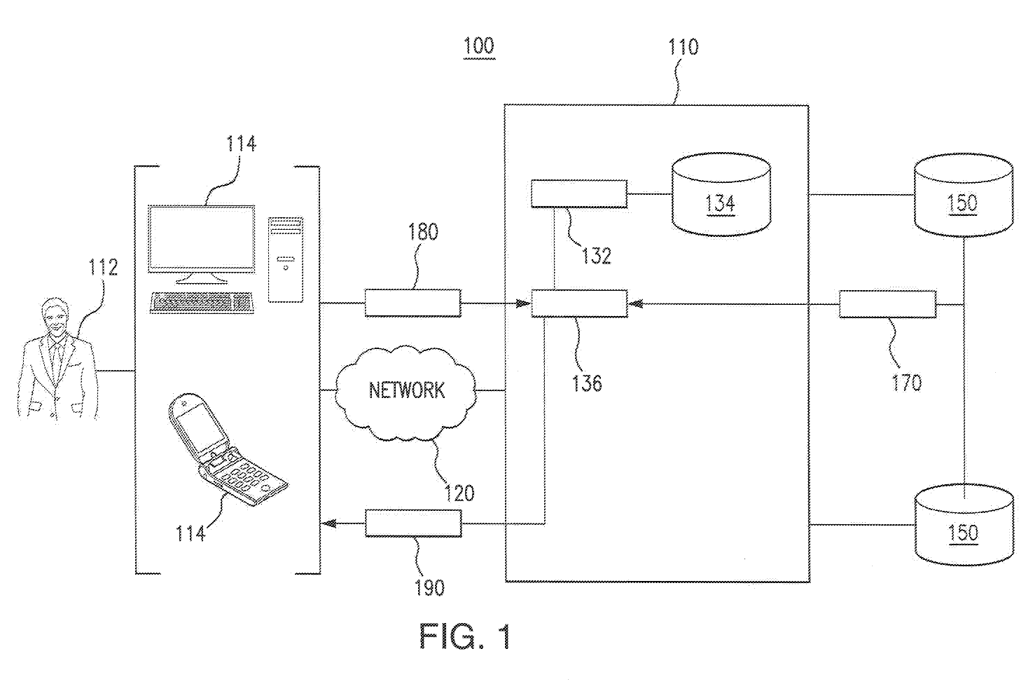

Embodiments of the present disclosure and its advantages are best understood by referring to FIGS. 1 through 13 of the drawings, like numerals being used for like and corresponding parts of the various drawings.

As the world becomes increasingly digital and interconnected, regulation of foreign transactions and services grows more complex and intricate leading to increased traffic over communications networks. The regulations, both of the source country and the destination country, may give rise to several issues including issues associated with tax, licensing, documentation, etc. For example, suppose a company based in country A wishes to build a warehouse in country B. In order for the company to build the warehouse in country B, the company may need to acquire financing in country B. The regulations of country A and/or country B may determine which loan provider the company uses, how much money the company may borrow, what type of loan is allowed, the amount of tax withholding on the loan, and other related issues. However, loan providers in country B and country A may not be familiar with the regulations of the other country. As a result, the process by which the company acquires financing for its new warehouse may be slow and inefficient.

The system may provide features that reduce the traffic over a network of the system thereby improving the operation of the system. As one feature, the system may allow for subscriptions to and notification of information relevant to loans, such as loan regulations and tax regulations. As an example and not by way of limitation, the company of the previous example may subscribe to a loan regulation of country B. When the loan regulation changes (e.g., to increase reporting requirements), the system may communicate an alert to the company indicating that the loan regulation has changed. In this manner, the company would not be required to periodically check the loan regulation in order to determine whether the loan regulation has changed. Rather, the system may notify the company when the loan regulation changes thus reducing network traffic associated with checking regulations.

As another feature, the system may store information about previous loans and use that information to predict information about future loans, such as interest rates and exchange rates. As an example and not by way of limitation, the system may store information pertaining to previous loans in country B of the previous example. When the company indicates that it wants to apply for a loan from country A to country B, the system may predict the exchange rate of the loan based on the exchange rates of the previous loans in country B. For example, the system may determine that the exchange rates of loans in country B has been increasing the past few months and determine, in response, that the exchange rate for the company's loan will be higher than the average exchange rate of the previous month. The system may also use current rates from public sites, such as Reuters or Bloomberg, to predict the information. In this manner, the company would not be required to apply for the loan before receiving estimates on important information. Rather, the system may predict this information for the company prior to the company applying for the loan thus reducing network traffic associated with loan applications.

As yet another feature, the system may store information about previous loans and previous competitor loans, and use that information to determine a loan offer. As an example and not by way of limitation, a loan officer may want to make a competitive offer to the company so the company will select the loan officer and/or the institution to fund the loan. The loan officer may indicate to the system that the company wants to take out a loan, and the system may analyze stored information about previous loans the company has taken out to determine what products were accepted or rejected by the company previously. For example, the system may determine that the company previously selected competitor products because the competitors had lower interest rates and/or more favorable warranties than the loan officer's products. Based on that information, the loan officer may select or tailor a product that has a lower interest rate or a more favorable warranty than previously offered products. In this manner, the system would assist in determining a competitive product to offer the company thus reducing network traffic associated with communicating noncompetitive offers.

As another feature, the system may determine an order of operation for a requested loan. As an example and not by way of limitation, the system may assist participants in the loan process, such as the company of the previous example, the lender, underwriter, appraiser, inspector, and any other appropriate participant, to determine a schedule of tasks to be performed to close the loan. The system may analyze information pertaining to previous loans to determine the dates by which an appraisal and an inspection should be completed for the loan to close by a required closing date, for example. The system may also analyze the information to estimate a closing date for the loan. The system may further update this estimated closing date based on the date on which particular tasks are completed. Furthermore, the system may alert participants when it is their turn to begin a task. For example, if an inspection cannot begin until an appraisal is complete, the system may send an alert to the inspector when the appraiser has submitted an appraisal. Moreover, the system may store and/or maintain documents pertaining to the loan so that the participants can access the documents. For example, the appraiser may upload the appraisal to the system and the inspector will be able to access the appraisal without contacting the appraiser. In this manner, the system may reduce the number of delays associated with the loan thereby reducing network traffic associated with handling and/or resolving delays and with contacting participants for documents.

As yet another feature, the system may contextualize information presented to a user based on the user's geographic location. As an example and not by way of limitation, the system may add or remove particular types of information based on the geographic location of the loan officer of the previous example. The system may be supplied with the location of the loan officer through the global positioning system, radio triangulation, Internet Protocol (IP) address, and any other appropriate location system. The system may store and reference location-based rules to determine what types of information are and are not relevant to a supplied location. For example, if the IP address of the loan officer is a Brazilian IP address, the system may present Brazilian loan regulations, Brazilian tax regulations, execution requirements, and/or other appropriate information pertinent to Brazil. The system may also exclude information not pertinent to Brazil from being presented, such as information pertaining to European Economic Area (EEA) passports. In this manner, the system may reduce network traffic associated with the communication of irrelevant or unnecessary information.

As another feature, the system may determine offers for other lenders. As an example and not by way of limitation, the loan officer of the previous example may not be willing to fund a loan amount because the amount is too high or the borrower presents too much risk. The loan officer may use the system to offer a portion of the loan amount (e.g., 20%) to other lenders. The system may allow the loan officer to select the lenders to whom to make offers and to whom to exclude from offers. The system may then send offers to the appropriate lenders. Each offer may include a link through which lenders may accept the offer and a timeout by which lenders must accept the offer before it is revoked. The loan officer may also select a secondary group of lenders to whom offers should be made if the loan is not fully funded and/or if an originally selected lender rejected the offer. In this manner, the system may reduce network traffic associated with communicating offers to individual lenders.

FIG. 1 illustrates a system 100 implementing a cross-border competencies tool. As provided in FIG. 1, system 100 may include a device 114, network 120, processing module 110, and databases 150. A user 112 may use device 114 to access processing module 110 over network 120. Processing module 110 may be used to aggregate and analyze various regulations of particular countries. Processing module 110 may then return the results of that analysis to device 114. In this manner, system 100 may allow user 112 to determine the most efficient way of providing services in a particular country.

To better understand the functions of system 100 and processing module 110, an example of servicing a loan will be used. However, it is understood that system 100 and processing module 110 may be used in a variety of contexts and areas in order to help user 112 understand the regulations of a foreign country, such as providing utilities, construction and zoning, sale of food products, and labor management.

User 112 may use device 114 to interact with system 100. For example, user 112 may use device 114 to request information about a country. Processing module 110 may then return the requested information to device 114. User 112 may comprise any number of appropriate entities. Device 114 may use a processor and a memory to execute an application in order to perform any of the functions described herein. Device 114 may be a mobile device such as a cell phone or tablet. Device 114 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 100. Device 114 may also include a user interface, such as a display, a touchscreen, a microphone, keypad, or other appropriate terminal equipment usable by user 112.

Network 120 facilitates communications between device 114 and processing module 110. This disclosure contemplates any suitable network 120 operable to facilitate communication between the components of system 100. Network 120 may include any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components. This disclosure contemplates end networks having one or more of the described properties of network 120. Due to operations performed by user 112, traffic over network 120 may increase to an undesirable level causing slowdowns and delays. For example, user 112 may check the status of loan and tax regulations unnecessarily, apply for loans with undesirable terms, make uncompetitive offers, cause delays in the loan process, request unnecessary or irrelevant information, and/or offer portions of loans to individual lenders. Performance of system 100 may be improved by reducing the amount of traffic over network 120. In particular embodiments, processing module 110 may provide features and/or perform functions that reduce traffic over network 120.

Processing module 110 may perform various functions in order to provide requested information to user 112. Processing module 110 represents any suitable component that subscribes user 112 to particular types of information, predicts information, determines offers for clients, schedules tasks, contextualizes information based on location, and offers portions of deals to other lenders. Processing module 20 may include a network server, any suitable remote server, a mainframe, a host computer, a workstation, a web server, a personal computer, a file server, or any other suitable device operable to communicate with device 114. In some embodiments, processing module 20 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of processing module 110 may be performed by any suitable combination of one or more servers or other components at one or more locations. In the embodiment where processing module 110 is a server, the server may be a private server, or the server may be a virtual or physical server. The server may include one or more servers at the same or remote locations. Also, processing module 110 may include any suitable component that functions as a server. Processing module 110 may include a processor 132, a memory 134, and a network interface 136 that performs the functions described herein. For example, memory 134 may perform storage functions such as storing loan regulations of foreign countries, processor 132 may analyze these loan regulations to determine a best course of conduct for user 112, and network interface 136 may send and receive communications associated with these loan regulations. Memory 134 and network interface 136 may be communicatively coupled to processor 132.

Memory 134 may store, either permanently or temporarily, data, operational software, or other information for processor 132. Memory 134 may include any one or a combination of volatile or non-volatile local or remote devices suitable for storing information. For example, memory 134 may include random access memory (RAM), read only memory (ROM), magnetic storage devices, optical storage devices, or any other suitable information storage device or a combination of these devices.

Processor 132 may control the operation and administration of processing module 110 by processing information received from network 120 and memory 134. Processor 132 may include any hardware and/or software that operates to control and process information. Processor 132 may be a programmable logic device, a microcontroller, a microprocessor, any suitable processing device, or any suitable combination of the preceding.

Network interface 136 represents any suitable device operable to receive information from network 120, transmit information through network 120, perform processing of information, communicate with other devices, or any combination of the preceding. For example, network interface 136 may receive user interactions from device 114. As another example, network interface 136 may communicate messages to device 114. Network interface 136 represents any port or connection, real or virtual, including any suitable hardware and/or software, including protocol conversion and data processing capabilities, to communicate through a LAN, WAN, or other communication system that allows processing module 110 to exchange information with device 114, network 120, or other components of system 100.

Processing module 110 may gather information from databases 150. Databases 150 may store information associated with particular countries. For example, databases 150 may store loan regulations and tax regulations associated with various countries. Processing module 110 may gather and store this information from databases 150. After the information has been stored, processing module 110 may use that information to respond to requests 180 from user 112.

Processing module 110 may receive a data feed 170 from databases 150. Data feed 170 may include loan regulations and/or tax regulations associated with various countries. For example, the loan regulations may indicate whether a foreign office is allowed to service a loan into that country, whether same-day funding and/or a swing-line loan is allowed, whether a cross-border license such as a European Economic Area (EEA) passport is required to service a loan in the country, and other requirements associated with servicing the loan. These other requirements may include booking requirements, documentation requirements, execution requirements, and/or disclosure requirements associated with servicing the loan. For example, data feed 170 may indicate that in order for a loan to be effective in a particular country, the loan must be written and executed by three witnesses and the terms of the loan must be disclosed to a particular agency. Processing module 110 may then use data feed 170 to inform user 112 how best to service a loan to a particular country.

Processing module 110 may perform various features that reduce traffic over network 120. For example, processing module 110 may allow for subscriptions and notifications, predict information associated with a loan, determine a competitive offer, determine a schedule of tasks for a loan, contextualize data based on geographic location, and determine an offer for another lender. In particular embodiments, processing module 110 may improve traffic over network 120 by performing any number of these features alone or in combination.

Processing module 110 may receive a request 180 from device 114. Request 180 may indicate a service to be performed by processing module 110. For example, request 180 may indicate that a company in country A is requesting a loan be provided in country B. Request 180 may also indicate that the loan should be provided in a particular currency. Processing module 110 may use stored information gathered from databases 150, such as regulations 170, to respond to request 180. For example, processing module 110 may determine based on the stored information that a loan provider is allowed to service a loan in country B according to the designated currency. As another example, processing module 110 may determine the amount of tax withholding on the loan required by the tax regulations of country B. This disclosure contemplates request 180 including borrower information, lender information, borrowing country, lending country, interest rate, currency, exchange rate, closing date, and/or any other appropriate information associated with a loan.

Processing module 110 may use information gathered and stored from databases 150 to form a response 190 to request 180. Processing module 110 may then communicate response 190 to device 114. Response 190 may include information associated with providing a requested service. For example, if the requested service is providing a loan in a particular country, then response 190 would include information associated with providing that loan in the country. As an example, response 190 may indicate the office locations that are allowed to service a loan of a particular currency in a designated country. As another example, response 190 may indicate the tax withholdings on the loan.

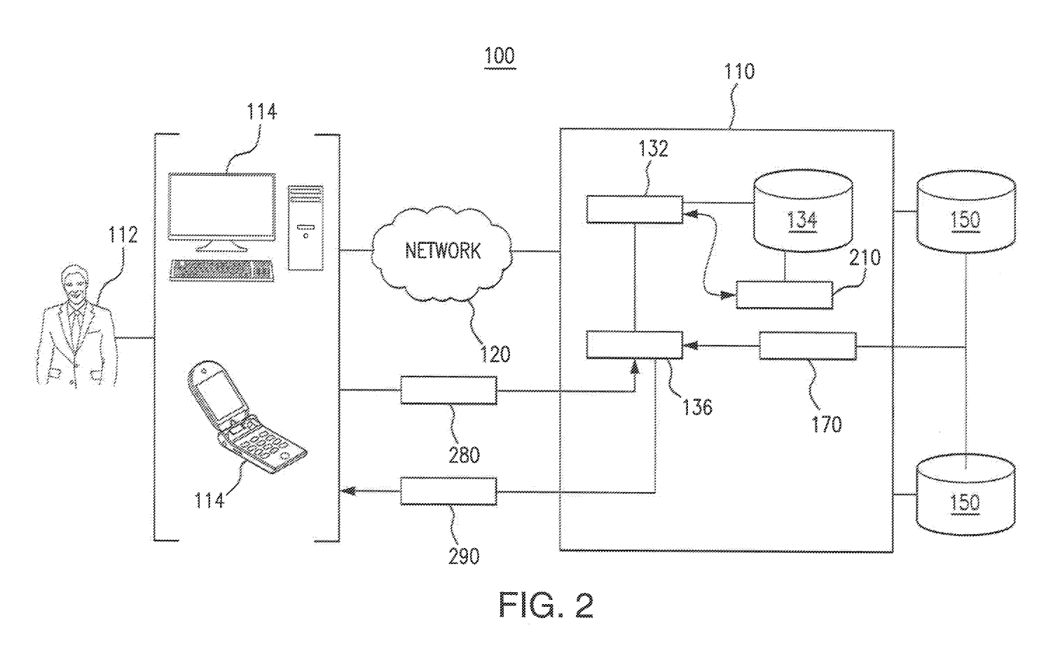

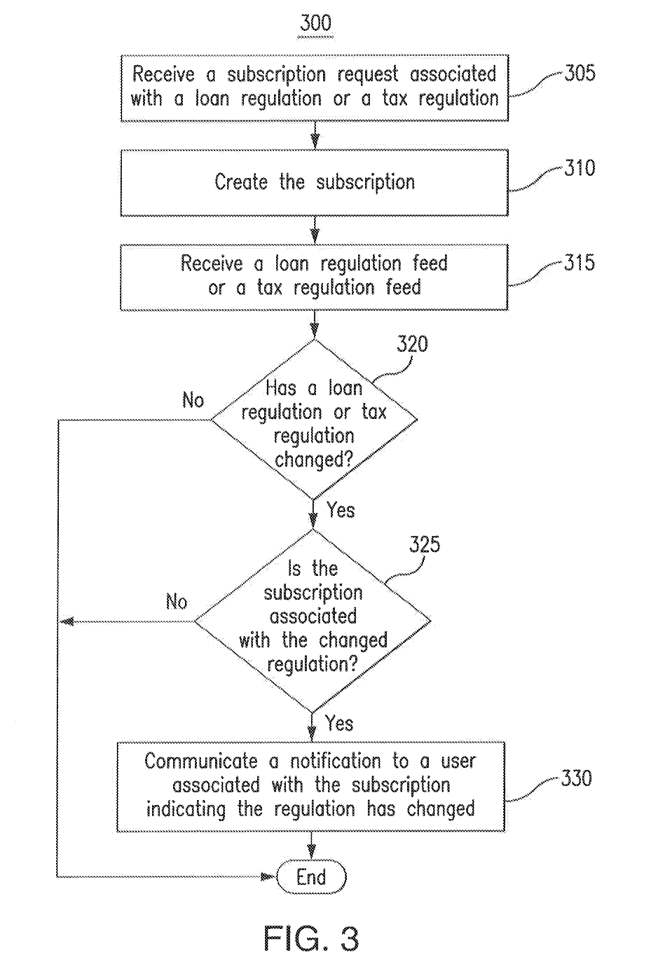

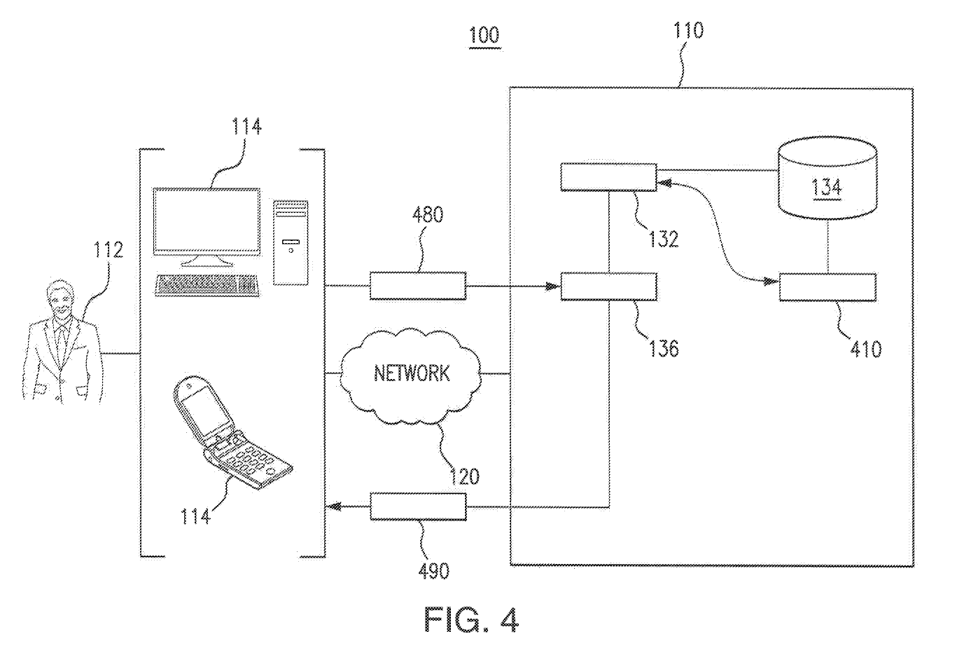

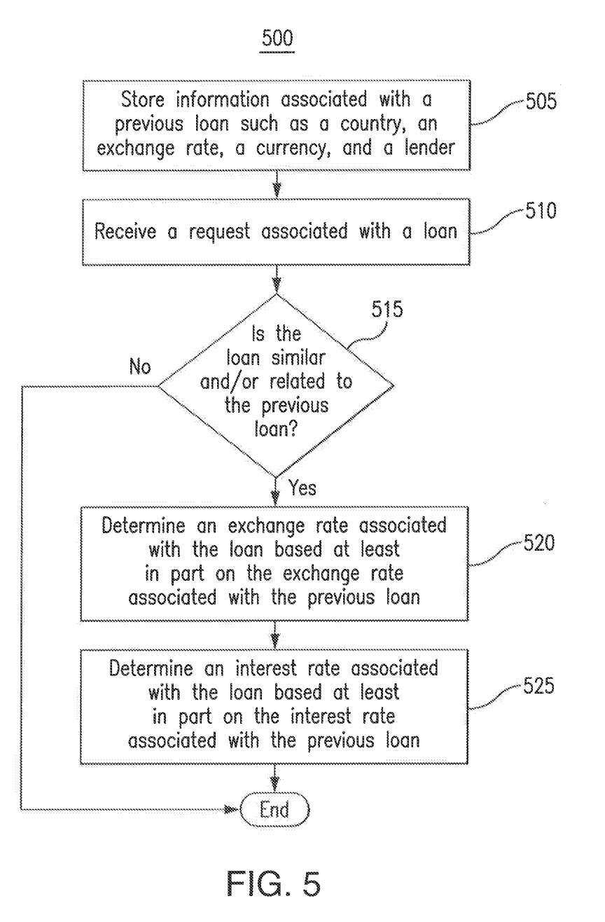

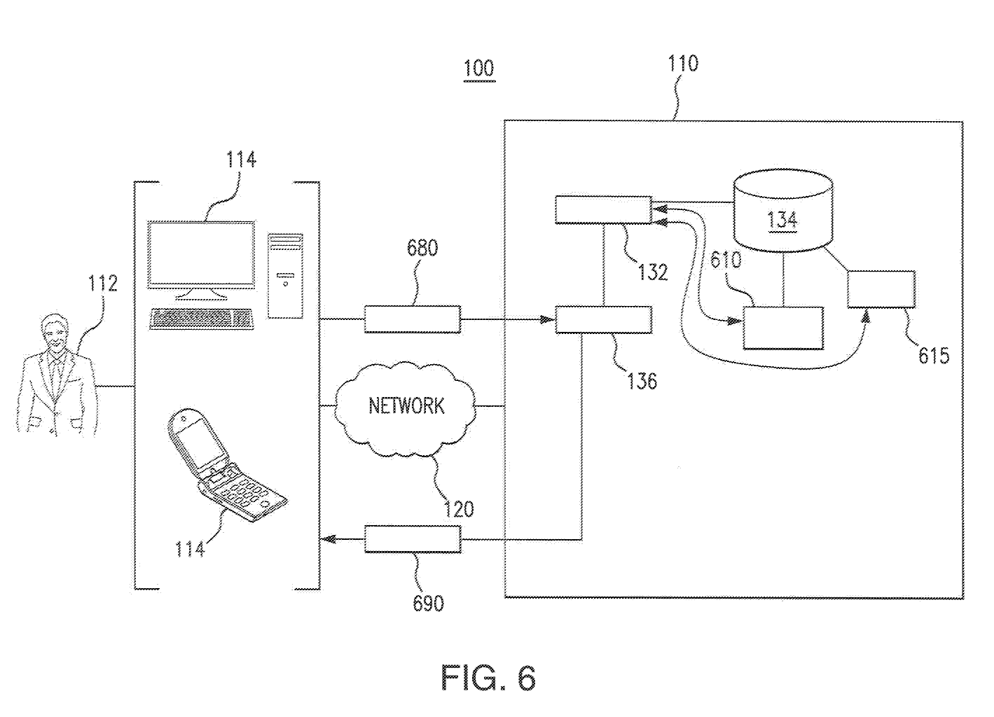

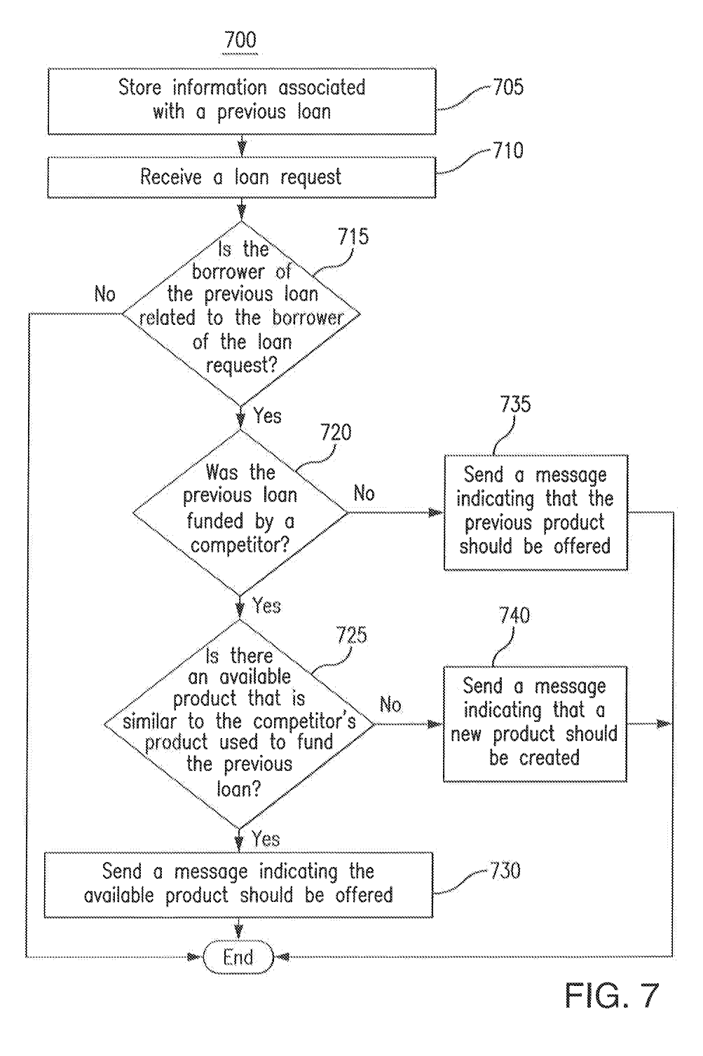

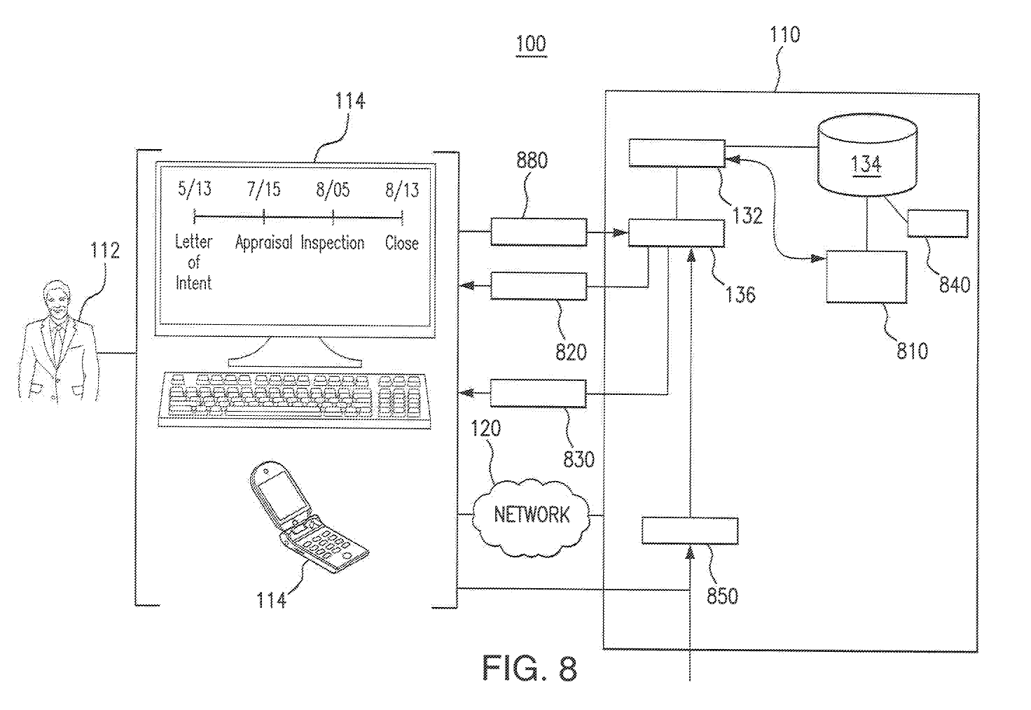

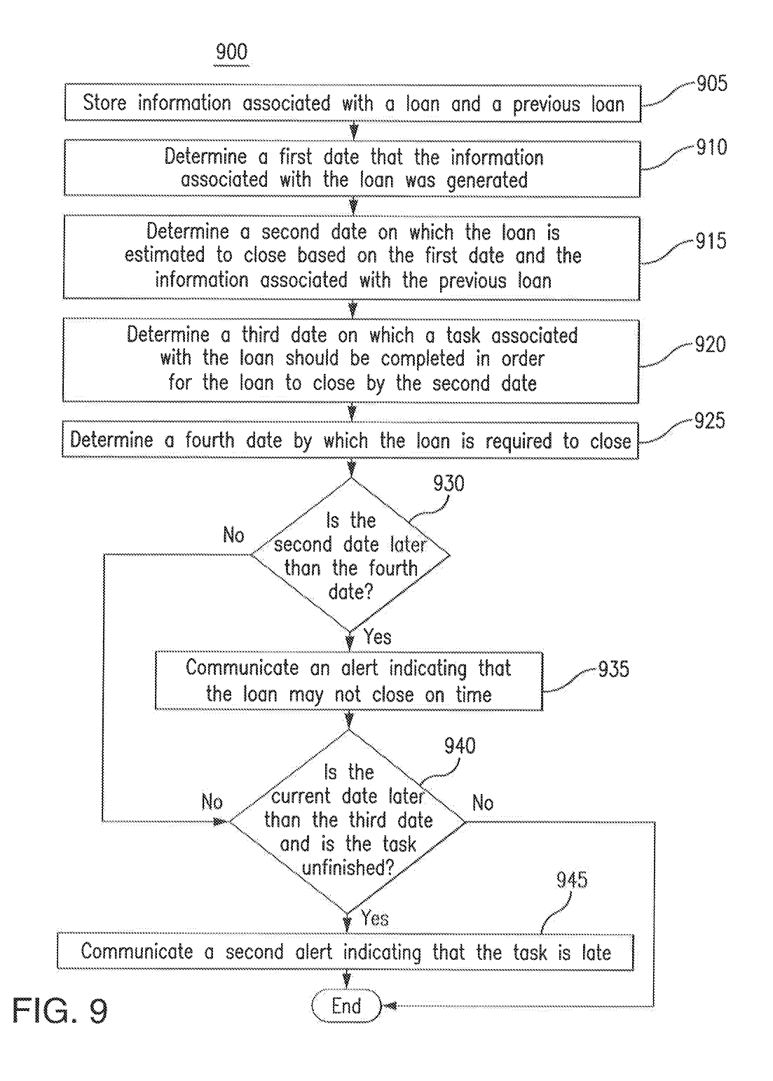

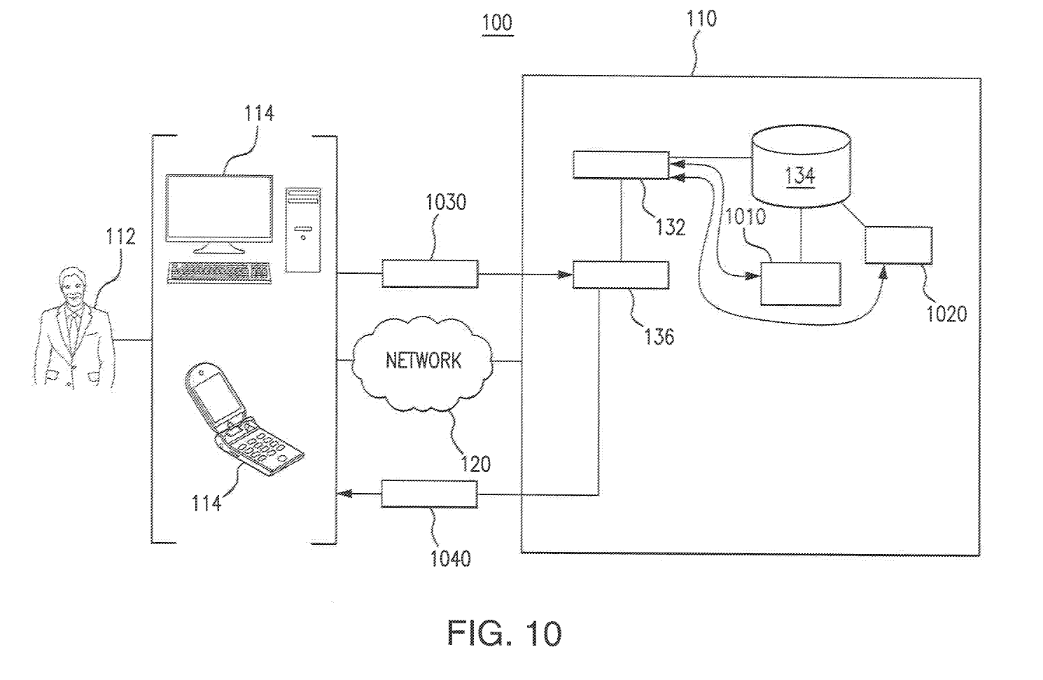

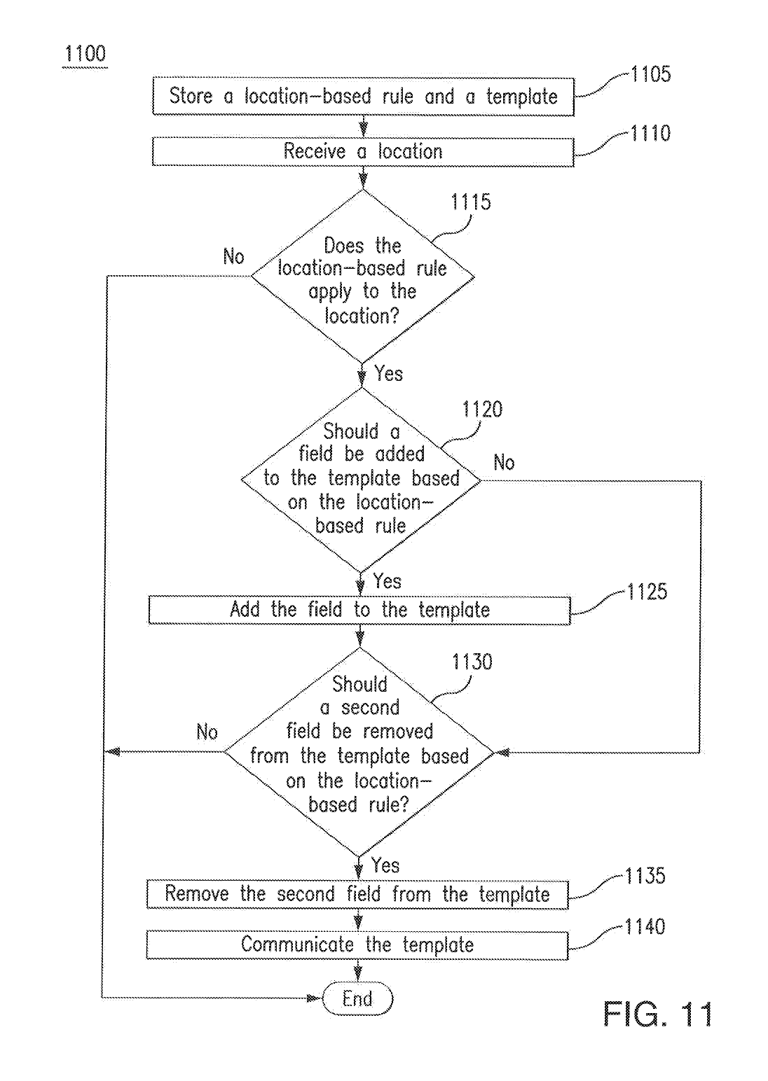

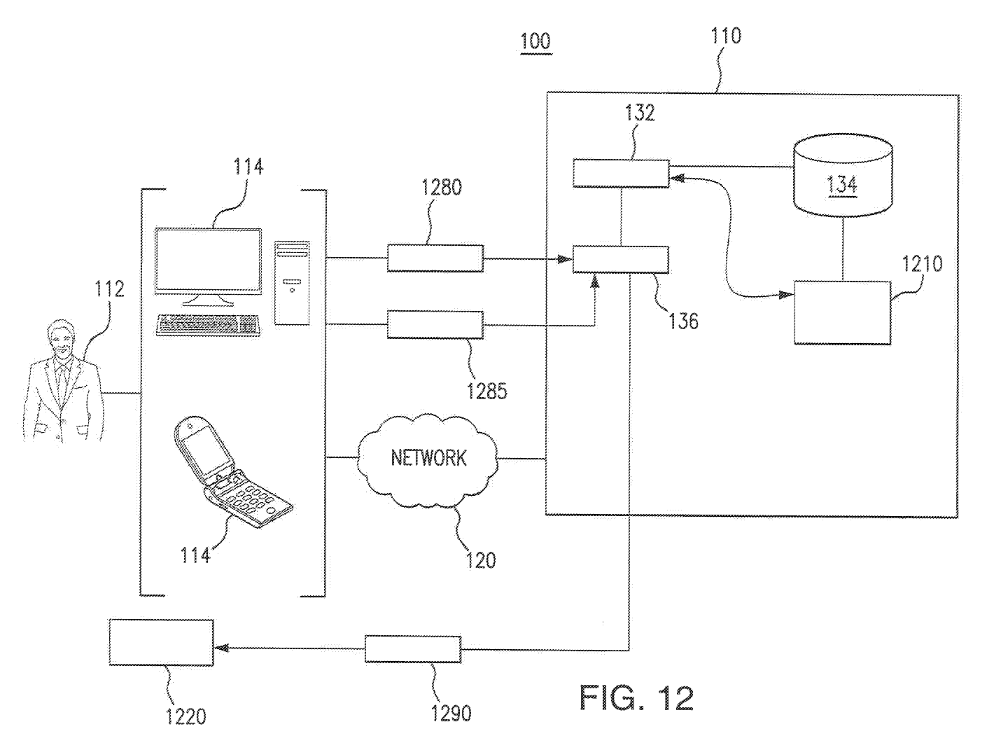

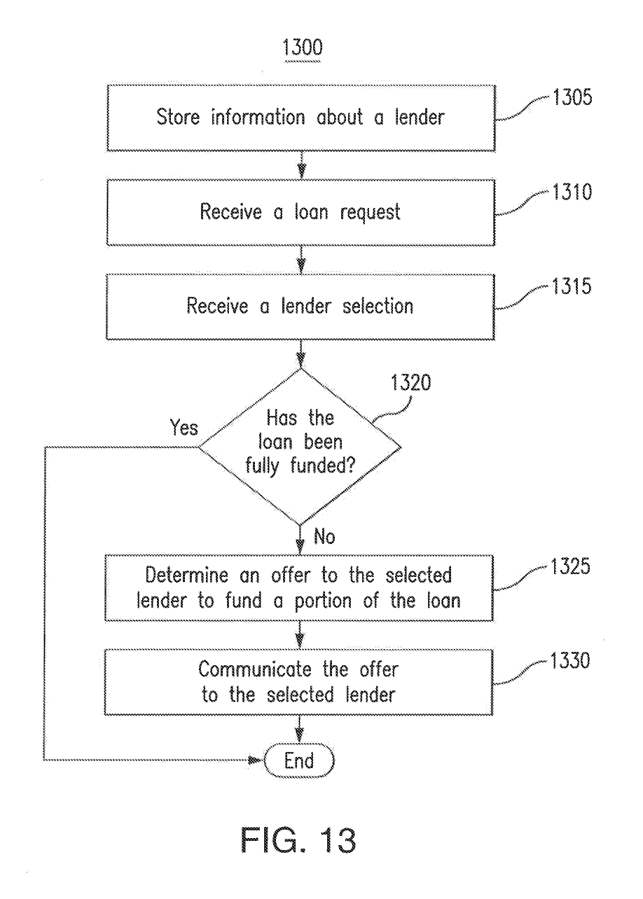

In operation, system 100 may perform various functions that may reduce traffic over network 120. These features include: providing subscriptions and notifications, predicting information, determining a competitive offer, determining a schedule of tasks, contextualizing information based on geolocation, and determining an offer to another lender. In providing subscriptions and notifications, system 100 may reduce traffic associated with users 112 checking information periodically in order to determine whether that information has changed. This function will be discussed with respect to FIGS. 2 and 3. In predicting information, system 100 may reduce traffic associated with loan applications. This function will be discussed with respect to FIGS. 4 and 5. In determining a competitive offer, system 100 may reduce traffic associated with making noncompetitive or rejected offers. This function will be discussed with respect to FIGS. 6 and 7. In determining a schedule of tasks, system 100 may reduce traffic associated with handling and/or resolving delays. This function will be discussed with respect to FIGS. 8 and 9. In contextualizing information, system 100 may reduce traffic associated with the communication of irrelevant or unnecessary information. This function will be discussed with respect to FIGS. 10 and 11. In determining an offer to another lender, system 100 may reduce traffic associated with communicating individual offers to individual lenders. This function will be discussed with respect to FIGS. 12 and 13.

Modifications, additions, or omissions may be made to system 100 without departing from the scope of the invention. For example, processing module 110 may retrieve information from databases 150 for a request 180 after receiving request 180. As another example, response 190 may include empty or null fields associated with missing information. Furthermore, the components of system 100 may be integrated or separated. For example, databases 150 may be incorporated into processing module 110.

FIGS. 2 through 13 further illustrate the operation of system 100. In these figures, certain elements of system 100 are omitted from these figures in order to emphasize other elements of system 100. However, system 100 may include each element depicted in FIGS. 1 through 13.

FIGS. 2 and 3 illustrate the system 100 managing subscriptions 210. In general, user 112 may subscribe to particular information associated with a loan. For example, user 112 may subscribe to a loan regulation associated with the loan. This disclosure contemplates user 112 subscribing to any appropriate information such as, for example, an exchange rate, a currency, a tax regulation and/or a loan amount. When user 112 subscribes to a loan regulation for example, processing module 110 may create a subscription 210 associated with user 112 and the loan regulation. Processing module 110 may then store and maintain the subscription 210. Processing module 110 may then analyze feed 170 from databases 150 to determine if the loan regulation has changed. For example, processing module 110 may determine if the loan regulation has changed to require the filing of an additional document in order to process a loan. When processing module 110 determines that the loan regulation has changed, processing module 110 reviews subscription 210 to determine that user 112 is subscribed to the loan regulation. Processing module 110 then communicates a notification 290 to user 112 in order to indicate that the loan regulation has changed. In this manner, user 112 may be apprised of changes to information associated with the loan associated with user 112.

FIG. 2 illustrates the system 100 of FIG. 1 managing subscriptions 210. As provided by FIG. 2, processing module 110 may receive subscription request 280 and feed 170. Processing module 110 may create and manage subscription 210. Processing module 110 may further communicate notifications 290 to device 114.

Processing module 110 may receive subscription request 280 from device 114. Subscription request 280 may indicate that user 112 wants to subscribe to a particular type of information associated with a loan. For example, subscription request 280 may indicate that user 112 wants to subscribe to a loan regulation and/or a tax regulation. This disclosure contemplates user 112 subscribing to any appropriate type of information such as, for example, an exchange rate, a currency, and/or a loan amount. After user 112 has subscribed to the loan regulation and/or tax regulation, processing module 110 may notify user 112 whenever the loan regulation and/or tax regulation changes.

Processing module 110 may create a subscription 210 based on subscription request 280. Subscription 210 may indicate the user 112 and the type of information to which the user 112 has subscribed. For example, if user 112 has subscribed to a loan regulation and a tax regulation, then subscription 210 may indicate user 112 subscribed to the loan regulation and the tax regulation. As another example, if user 112 has subscribed to a loan regulation and a tax regulation, then processing module 110 may generate two subscriptions 210, one corresponding to the loan regulation and the other corresponding to the tax regulation. This disclosure contemplates processing module 110 generating any appropriate number of subscriptions 210 based on subscription request 280. Processing module 110 may store subscription 210 in memory 134 and modify, disable, or delete subscription 210 based on subsequent subscription requests 280. Processing module 110 may refer to subscription 210 to determine whether a user 112 should be notified when a particular type of information changes.

As an example and not by way of limitation, user 112 and/or an institution associated with user 112 may have previously serviced and/or funded a loan. The loan may have involved a loan regulation and a tax regulation. User 112 may have subscribed to these two regulations. As a result, processing module 110 may have generated and stored two subscriptions 210, one corresponding to the loan regulation and one corresponding to the tax regulation. During the lifetime of the loan, user 112 may rely on these subscriptions 280 to determine when changes to the loan regulation and/or tax regulation occur.

In particular embodiments, processing module 110 may generate subscriptions 280 based on an industry designation of user 112. For example, user 112 may specify that he is associated with the automobile industry. In response to that specification, processing module 110 may subscribe user 112 to a tax regulation that applies a particular tax rate on automobile sales. If the tax rate changes, then processing module 110 will notify user 112 of that change. As another example, processing module 110 may maintain a subscription 280 based on the automobile industry. Processing module 110 may then associate with that subscription 280, users 112 who specify that they are associated with the automobile industry. When a regulation that affects the automobile industry changes, processing module 110 may notify the users 112 associated with the automobile industry about the change.

Processing module 110 may associate subscriptions 280 with user 112. For example, subscription 280 may include information that identifies the user 112 associated with subscription 280. As another example, processing module 110 may store and/or maintain separate user profiles that may be associated with subscriptions 280. Processing module 110 may then store associations between the user profiles and their corresponding subscriptions 280. For example, processing module 110 may store and/or maintain a profile corresponding to user 112. When user 112 subscribes to a loan regulation and/or a tax regulation, his profile may be associated with subscriptions 280 associated with the loan regulation and/or tax regulation.

Processing module 110 may receive feed 170 from databases 150. Processing module 110 may analyze feed 170 to determine whether particular types of information have changed. In particular embodiments, feed 170 may indicate that a change has occurred. In other embodiments processing module 110 may compare information in feed 170 with information stored in or retrieved by processing module 110 to determine whether a change has occurred. Processing module 110 may receive any appropriate number of feeds 170. As an example and not by way of limitation, processing module 110 may receive a feed 170 corresponding to a loan regulation and a feed 170 corresponding to a tax regulation. Processing module 110 may analyze these feeds 170 and determine that the loan regulation and/or tax regulation has changed. After determining that a type of information has changed, processing module 110 may appropriately notify user 112.

Processing module 110 may analyze subscription 210 and the determined change to determine whether a notification 290 should be sent to user 112. For example, if processing module 110 determines that a loan regulation has changed, processing module 110 may analyze subscription 210 to determine whether user 112 has subscribed to that loan regulation. If user 112 is subscribed to that loan regulation, processing module 110 may then communicate a notification 290 to user 112. In particular embodiments, notification 290 may include a message indicating that information has changed. For example, the message may indicate that a loan regulation has changed. The message may further indicate the changes that occurred to the loan regulation. After device 114 receives notification 290, device 114 may present notification 290 and/or a message to user 112 indicating that information has changed. In particular embodiments, notification 290 may include a hyperlink through which a user 112 may access an explanation of the change. For example, notification 290 may indicate that a loan regulation and/or a tax regulation has changed. Notification 290 may further include a hyperlink. When user 112 clicks the hyperlink, he may be taken to a webpage describing the changes to the loan regulation and/or tax regulation.

As an example and not by way of limitation, user 112 may subscribe to a particular loan regulation in Canada because user 112 has taken out several loans in Canada. Processing module 110 may receive feed 170 indicating that the loan regulation has changed to require the filing of additional documents in order to take out loans in Canada. After determining that the changes occurred, processing module 110 may analyze subscription 210 to determine that user 112 has subscribed to the particular loan regulation. Processing module 110 may then communicate notification 290 to user 112. Notification 290 may include a message that indicates the loan regulation has changed. The message may further indicate that the loan regulation has changed to require the filing of additional documents to take out a loan in Canada. When device 114 receives notification 290, device 114 may display the message to user 112 in order to inform user 112 of the change. In this manner, user 112 may be notified of changes without requiring the user 112 to check if information has changed each time the user 112 wishes to know if a change has occurred.

As another example and not by way of limitation, user 112 may subscribe to the contact information of a Canadian employee who has assisted user 112 previously on a loan. Processing module 110 may receive a feed 170 associated with employee contact information. When processing module 110 determines, based on feed 170, that the Canadian employee's contact information has changed, processing module 110 may notify user 112 of that change. User 112 may then update an address book to reflect the Canadian employee's changed contact information.

Although this disclosure describes processing module 110 performing certain actions with respect to FIG. 2, this disclosure contemplates processor 132, memory 134, and network interface 136 of processing module 110 performing these actions. The illustration of system 100 in FIG. 2 does not specifically illustrate all of the elements from the illustration of system 100 in FIG. 1 so that particular elements of system 100 may be emphasized. However, system 100 of FIG. 2 includes all the elements of system 100 in FIG. 1.

FIG. 3 is a flowchart illustrating a method 300 for managing subscriptions 210 using the system 100 of FIG. 1. Processing module 110 may perform method 300. As provided by FIG. 3, processing module 110 may begin by receiving a subscription request associated with a loan regulation or a tax regulation in step 305. In response to receiving the subscription request, processing module 110 may create the subscription in step 310. The subscription may indicate a user associated with the subscription and the loan regulation or the tax regulation. When the loan regulation or tax regulation changes, processing module 110 may notify the user according to the subscription.

In step 315, processing module 110 may receive a loan regulation feed or a tax regulation feed. The feeds may provide information on the loan regulation and the tax regulation. For example, the feeds may indicate whether the loan regulation or the tax regulation have changed. In step 320, processing module 110 may determine whether the loan regulation or tax regulation have changed. Processing module 110 may analyze the loan regulation feed and tax regulation feed to make this determination. If the loan regulation and tax regulation have not changed, method 300 may conclude.

If the loan regulation or the tax regulation have changed, method 300 continues from step 325 and processing module 110 determines whether the subscription is associated with the changed regulation. For example, if processing module 110 determines that the loan regulation has changed, processing module 110 may then proceed to determine whether the subscription is associated with the loan regulation. If the subscription is not associated with the changed regulation, method 300 may conclude.

If the subscription is associated with the changed regulation, method 300 continues from step 330 and processing module 110 communicates a notification to a user associated with the subscription indicating the regulation has changed. For example, if the loan regulation has changed, processing module 110 may communicate a notification to a user indicating that the loan regulation has changed. In particular embodiments, the notification may further indicate in what ways the regulation has changed. For example, if the loan regulation has changed to require an increased minimum down payment in order to take out a loan, the notification may indicate that the loan regulation has changed and the increased minimum down payment.

In particular embodiments, by creating and maintaining subscriptions, processing module 110 may inform user 112 of changes to particular information pertinent to user 112 without requiring user 112 to send requests to processing module 110 each time user 112 wishes to know whether particular information has changed. In so doing, traffic across network 120 may be reduced.

Modifications, additions, or omissions may be made to method 300 depicted in FIG. 3. Method 300 may include more, fewer, or other steps. For example, steps may be performed in parallel or in any suitable order. While discussed as processing module 110 performing the steps, any suitable component of system 100, such as device 114 for example, may perform one or more steps of the method.

FIGS. 4 and 5 illustrate system 100 predicting information associated with a loan. In general, when user 112 is preparing to apply for a loan, user 112 would want to know particular types of information prior to applying. For example, user 112 may want to know an interest rate or an exchange rate for the loan. However, this type of information may not be available until after the application has been made, because, for example, a lender may need to check the background and credit history of user 112 before estimating an interest rate.

Processing module 110 may predict the types of information that user 112 is interested in seeing prior to applying for the loan. For example, processing module 110 may analyze previous loans that are similar to the loan the user 112 wishes to open in order to predict types of information such as an exchange rate or an interest rate. For example, if user 112 wants to open a loan in Brazil, processing module 110 may examine previous loans opened in Brazil. Processing module 110 may examine the interest rates and exchange rates associated with these previous loans in order to predict the exchange rate or interest rate for the loan that the user 112 wants to open. Processing module 110 may then communicate the predicted information to user 112 in order to help user 112 decide whether to apply for the loan. In this manner, processing module 110 may reduce the amount of network traffic associated with applying for and opening a loan.

FIG. 4 illustrates system 100 of FIG. 1 predicting information associated with the loan. As provided by FIG. 4, processing module 110 may receive a loan request 480 associated with a loan. Processing module 110 may determine whether the loan is similar to previous loans by comparing loan request 480 with stored previous loans 410. If the loan is similar to the previous loans 410, processing module 110 may use previous loans 410 to predict particular types of information associated with the loan. Processing module 110 may then communicate the predicted information 490 to user 112.

Loan request 480 may include information associated with a loan. For example, loan request 480 may include borrower information, lender information, borrowing country, lending country, currency, closing date, and any other appropriate information. This information may indicate the type of loan that user 112 wants to open. As an example and not by way of limitation, loan request 480 may indicate that a toy company in the United States wants to borrow an amount of Canadian dollars in order to build a warehouse in Canada. Processing module 110 may use the information included in loan request 480 to predict particular types of information associated with the loan. Processing module 110 may compare information included in loan request 480 with stored previous loan 410. Previous loan 410 may be stored in memory 134 and may include information associated with previous loans. For example, previous loan 410 may include borrower information, lender information, borrowing country, lending country, exchange rate, interest rate, currency, loan amount, and closing date. Memory 134 may store any appropriate number of previous loans 410. By comparing information in loan request 480 with information in previous loans 410, processing module 110 may determine the previous loans 410 that are similar and/or related to the loan associated with loan request 480. Using the previous example of the toy company, processing module 110 may determine that a set of previous loans 410 that includes loans taken out in Canada within the past month are the most similar to the loan that the toy company wants to open. Processing module 110 may then examine the information associated with the set of previous loans 410 to predict information associated with the loan that the toy company wants to open.

Processing module 110 may perform any appropriate numerical and/or historical analysis to predict information for the loan associated with loan request 480. For example, processing module 110 may determine that the interest rate and/or exchange rate associated with previous loans 410 has been increasing at a particular rate because the demand for loans has been increasing in the country associated with previous loans 410. Processing module 110 may then extrapolate the interest rate and/or exchange rate to the closing date indicated in loan request 480 to predict an interest rate for the loan associated with loan request 480. As another example, processing module 110 may analyze metrics measuring demand for loans in a country based on information associated with previous loans 410. Processing module 110 may then extrapolate the demand out to the closing date of a particular loan. Then, based on the extrapolated demand, processing module 110 may predict an interest rate for the loan. As yet another example, processing module 110 may receive a data feed that includes information regarding exchange rates. The data feed may update as the currency exchange rate on the market changes. Processing module 110 may analyze these changes to predict what the currency exchange rate of the market will be at a later time, such as the closing date of a loan. Based on that determination, processing module 110 may predict an exchange rate for the loan at closing.

Using the previous example of the toy company, processing module 110 may examine the set of previous loans 410 taken out in Canada and determine that the interest rate has been holding steady, but that the exchange rate from U.S. dollars to Canadian dollars has been decreasing. Based on this information, processing module 110 may predict that the interest rate for the toy company's loan may be similar to the average interest rate of the set of previous loans 410 and that the exchange rate for the loan may be slightly lower than the average exchange rate of the set of previous loans 410. This disclosure contemplates processing module 110 predicting any appropriate type of information associated with a loan using any appropriate analysis method on any appropriate types of information associated with previous loans 410.

For example, processing module 110 may predict, based on previous loans 410, the competitors that will make offers to the toy company. For example, processing module 110 may store information identifying the lenders who also made offers to the toy company on previous loans 410. After processing module 110 determines that the toy company's current loan is similar and/or related to the previous loans 410, processing module 110 may predict that the previous competitors will make offers to the toy company for its current loan. As another example, processing module 110 may predict, based on previous loans 410, the lenders to whom portions of the toy company's loan should be offered for funding. For example, processing module 110 may store information identifying the lenders who funded portions of previous loans 410 for the toy company. After processing module 110 determines that the toy company's current loan is similar and/or related to the previous loans 410, processing module 110 may predict that the previous lenders should be offered portions of the current loan for funding. As yet another example, processing module 110 may predict, based on previous loans 410, the employees who can assist in processing the toy company's loan. For example, processing module 110 may store information identifying the employees who assisted on previous loans 410. After processing module 110 determines that the toy company's current loan is similar and/or related to the previous loans 410, processing module 110 may predict that the employees who assisted on the previous loans 410 can assist on the current loan.

After predicting the information, processing module 110 may communicate the predicted information 490 to user 112. After device 114 receives predicted information 490, device 114 may present the predicted information to user 112 in order to help user 112 decide whether to open loan or not. Using the previous example of the toy company, processing module 110 may predict that the interest rate for the loan will hold steady as compared to previous loans 410 but that the exchange rate will decrease as compared to previous loans 410. Device 114 may present this information to user 112 and user 112 may decide not to open the loan at this time. In this manner, user 112 may glean important information without applying for and/or opening a loan. This may reduce the amount of network traffic over network 120.

In particular embodiments, processing module 110 may use information received from databases 150 to make predictions. For example, processing module 110 may receive exchange rates and/or interest rates from databases 150. These rates may be current. Processing module 110 may then use these rates to predict an exchange rate and/or interest rate for a loan. This disclosure contemplates processing module 110 using any type of received information to make predictions.

Although this disclosure describes processing module 110 performing certain actions with respect to FIG. 4, this disclosure contemplates processor 132, memory 134, and network interface 136 of processing module 110 performing these actions. The illustration of system 100 in FIG. 4 does not specifically illustrate all of the elements from the illustration of system 100 in FIG. 1 so that particular aspects of system 100 may be emphasized. However, system 100 of FIG. 4 includes all the elements of system 100 in FIG. 1.

FIG. 5 is a flowchart illustrating a method 500 for predicting information associated with a loan using the system 100 of FIG. 1. Processing module 110 may perform method 500. Processing module 110 may begin by storing information associated with a previous loan such as a country, an exchange rate, a currency, and a lender in step 505. This information associated with the previous loan may be used to predict information associated with future loans.

Method 500 continues from step 510 and processing module 110 receives a request associated with the loan in step 510. This request may include borrower information, lender information, borrowing country, lending country, loan amount, currency, and closing date. For example, the request may indicate that a toy company in the United States wants to take out a loan in Canada in order to open a new warehouse.

In step 515, processing module 110 may compare the information in the request with the stored information associated with the previous loan. For example, processing module 110 may determine whether the loan is occurring in the same country as the country associated with the previous loan. Using the previous example, processing module 110 may determine whether the previous loan also took place in Canada. If the previous loan also took place in Canada, processing module 110 may determine that the loan and the previous loan are similar and/or related and continue to predict information for the loan by using the information associated with the previous loan. This disclosure contemplates processing module 110 comparing any appropriate types of information to determine whether the loan is similar to the previous loan. For example, processing module 110 may compare borrower information, lender information, currency, and/or closing dates. If processing module 110 determines that the loan is not similar and are related to the previous loan, processing module 110 may conclude.

If processing module 110 determines that the loan is similar and/or related to the previous loans, processing module 110 may continue to predict information associated with the loan based at least in part upon information associated with the previous loan. For example, method 500 may continue from step 520 and processing module may determine an exchange rate associated with the loan based at least in part on the exchange rate associated with the previous loan. Processing module 110 may further determine interest rate associated with the loan based at least in part upon the interest rate associated with the previous loan in step 525. This disclosure contemplates processing module 110 determining any appropriate type of information associated with the loan based at least in part upon any appropriate type of information associated with the previous loan. In particular embodiments, because system 100 may predict information associated with a loan, system 100 may reduce the amount of traffic over network 120.

Modifications, additions, or omissions may be made to method 500 depicted in FIG. 5. Method 500 may include more, fewer, or other steps. For example, steps may be performed in parallel or in any suitable order. While discussed as processing module 110 performing the steps, any suitable component of system 100, such as device 114 for example, may perform one or more steps of the method.

FIGS. 6 and 7 illustrate system 100 determining an offer. In general, whenever a potential borrower desires to obtain a loan, the borrower may shop the loan around to several potential lenders. User 112 may be one of these lenders. User 112 will want to offer the most competitive product to the borrower in order to win the loan. User 112 may use processing module 110 to determine the most competitive product to offer the borrower.

Processing module 110 may analyze previous offerings made by user 112 and by competitors to determine which products the borrower tends to pick. Based on that information, processing module 110 may then provide a recommendation to user 112. For example, processing module 110 may recommend that user 112 offer a specific product or that user 112 create a particular type of product in order to win the loan. In this manner, processing module 110 may reduce the amount of network traffic associated with rejected offers and/or non-competitive offers.

FIG. 6 illustrates the system 100 of FIG. 1 determining an offer 690. As provided by FIG. 6, processing module 110 may receive a loan request 680. Server 180 may then analyze a previous offering 610 and a previous competitor offering 615 in order to determine offer 690. Processing module 110 may then communicate offer 690 to user 112 in order to help user 112 win the loan associated with loan request 680.

Processing module 110 may receive loan request 680 associated with a loan. Loan request 680 may include information associated with the loan such as borrower information, borrower country, lending country, currency, loan amount, and closing date. This disclosure contemplates loan request 680 including any appropriate type of information associated with the loan. As an example and not by way of limitation, loan request 680 may indicate that a toy company in the United States wants to take out a loan in Canada in order to open a warehouse. Processing module 110 may use the information included in request loan request 680 in order to determine an offer 690 for the borrower.

In order to determine offer 690, processing module 110 may analyze a stored previous offering 610. Previous offering 610 may include information associated with previous offers made by user 112 and/or an institution associated with user 112. Previous offering 610 may also include information associated with the borrower such as, for example, whether the borrower accepted the previous offer and/or reasons supplied by the borrower for accepting or rejecting the previous offer. As an example and not by way of limitation, previous offering 610 may indicate that user 112 had previously offered a first loan product which was rejected by the borrower. Previous offering 610 may further indicate that the borrower rejected the first loan product because the interest rate was too high. Previous offering 610 may also indicate that user 112 had not offered previously a second loan product. Based on this information, user 112 may decide to offer the second loan product rather than the first loan product. This disclosure contemplates previous offering 610 including any appropriate information associated with a previous offer.

Processing module 110 may further analyze a stored previous competitor offering 615 to determine the offer 690. Previous competitor offering 615 may include information associated a previous offer made by a competitor. For example, previous competitor offering 615 may indicate a previous competitor product, borrower information, currency, interest rate, country, exchange rate, and/or any other appropriate information. Previous competitor offering 615 may further indicate whether the borrower accepted the previous competitor offer and/or reasons supplied by the borrower for accepting and/or rejecting the previous competitor offer. As an example and not by way of limitation, previous competitor offering 615 may indicate that a competitor offered a second loan product that was accepted by the borrower. Previous competitor offering 615 may further indicate that the borrower accepted the second loan product because of its low interest rate and because it included a favorable warranty. This disclosure contemplates previous offering 610 and competitor offering 615 being accepted or rejected for any appropriate reason. By analyzing previous offering 610 and previous competitor offering 615, processing module 110 may determine offer 690. This disclosure contemplates processing module 110 analyzing any appropriate number of previous offerings 610 and any appropriate number of previous competitor offerings 615 to determine offer 690.

Processing module 110 may determine and communicate offer 690 to user 112. Processing module 110 may use offer 690 to recommend to user 112 a product to offer the potential borrower in order to win the loan. For example, after analyzing previous offering 610 and previous competitor offering 615, processing module 110 may recommend that user 112 offer a product with a similar interest rate to the second loan product. Furthermore, processing module 110 may recommend that user 112 include the favorable warranty that accompanied the second loan product. User 112 may then use offer 690 to offer a competitive offer to the potential borrower. In this manner, processing module 110 may reduce the amount of traffic over network 120 by reducing the amount of traffic associated with rejected and/or non-competitive offers.

In particular embodiments, processing module 110 may further determine metrics associated with the offer 690 to assist user 112 in deciding whether to make the offer 690 to a borrower. For example, processing module 110 may receive a data feed that indicates the exchange rate of a currency associated with the loan request 680. Based on that data feed, processing module 110 may determine a profitability metric associated with the currency of the loan request 680. Sever 110 may then communicate the profitability of the currency as part of offer 690 in order to assist user 112 in determining whether to communicate offer 690 to the borrower. As another example, processing module 110 may determine a risk metric associated with various loan products. Processing module 110 may determine, for example, the risk associated with offering a competitor product and communicate that risk to user 112 as part of offer 690 in order to assist user 112 in deciding whether to offer a competitor's product or not.

Processing module 110 may further alert user 112 of products that were not previously available. For example, since the time of the previous offering 610, a new product pertaining to the country and currency of the loan request 680 may have become available. This disclosure contemplates any appropriate new product pertaining to any appropriate type of information associated with loan request 680. User 112 may not have been aware of the new product. However, processing module 110 may communicate as part of offer 690 that, based on the country and the currency associated with the loan request 680, the new product is an option that user 112 may select to offer to the borrower. In this manner, user 112 may be apprised of available products that can be offered to borrowers.

In particular embodiments, offer 690 may include a list of products that were previously offered and a list of products that were not previously offered. When device 114 receives offer 690, it may present on a display, the lists. User 112 may analyze the lists to determine the best product to offer to the borrower. The lists may further provide information such as why particular products were accepted or rejected, and why particular products were or were not offered.

Although this disclosure describes processing module 110 performing certain actions with respect to FIG. 6, this disclosure contemplates processor 132, memory 134, and network interface 136 of processing module 110 performing these actions. The illustration of system 100 in FIG. 6 does not specifically illustrate all of the elements from the illustration of system 100 in FIG. 1 so that particular aspects of system 100 may be emphasized. However, system 100 of FIG. 6 includes all the elements of system 100 in FIG. 1.

FIG. 7 is a flowchart illustrating a method 700 for determining offers using the system 100 of FIG. 1. Processing module 110 may perform method 700. Processing module 110 may begin by storing information associated with a previous loan in step 705. The information may include a previous offer that was accepted and/or rejected by the borrower and a previous competitor offer that was accepted and/or rejected by the borrower. The information may further include any reasons supplied by the borrower for accepting and/or rejecting either offer.

In step 710, processing module 110 may receive a loan request associated with a loan. For example, the loan request may include information such as borrower information, lender information, borrower country, lending country, currency, and closing date. Processing module 110 may use the information included in the loan request to determine a competitive offer.

Processing module 110 may analyze the stored information and the information in the loan request to determine a competitive offer. For example, method 700 may continue from step 715 and processing module 110 may determine whether the borrower of the previous loan is related to the borrower of the loan request. If the borrowers are not the same or related, processing module 110 may conclude. If processing module 110 determines that the borrowers are related or the same, processing module 110 may continue to analyze the stored information to determine the competitive offer.

For example, in step 720, processing module 110 may analyze the stored information to determine whether the previous loan was funded by a competitor. If the previous loan was not funded by a competitor but rather by user 112 and/or an institution associated with user 112, method 700 continues from step 735 and processing module 110 sends a message indicating that the previous product offered by user 112 and/or the institution associated with user 112 should be offered to fund the loan. In particular embodiments, the message may further indicate any changes that should be made to the previous product based on comments and/or reasons supplied by the borrower. For example, even though the borrower accepted the previous product offered by user 112, the borrower may have indicated that he would have liked the interest rate to be lower. In response to that comment, the message may indicate that the previous product should be offered but attempts to lower the interest rate should also be made.

If processing module 110 determines that the previous loan was funded by a competitor, method 700 continues from step 725 and processing module 110 determines if there is an available product that is similar to the competitor's product used to fund the previous loan. For example, if the competitor's product had a particular interest rate and a particular warranty, processing module 110 may determine whether there is an available product that has a similar interest rate and a similar warranty. If processing module 110 determines that there is no available product similar to the competitor's product, processing module 110 may send a message indicating that a new product should be created in step 740. The new product may be similar to the competitor's product.

If processing module 110 determines that there is an available product that is similar to the competitor's product, then method 700 continues from step 730 and processing module 110 sends a message indicating that the available product should be offered. In this manner, processing module 110 may reduce the amount of rejected and/or non-competitive offers made by user 112 thereby reducing the amount of traffic over network 120.

Modifications, additions, or omissions may be made to method 700 depicted in FIG. 7. Method 700 may include more, fewer, or other steps. For example, steps may be performed in parallel or in any suitable order. While discussed as processing module 110 performing the steps, any suitable component of system 100, such as device 114 for example, may perform one or more steps of the method.

FIGS. 8 and 9 illustrate system 100 of FIG. 1 determining an order of operation. In general, several steps occur before a loan can close. For example, after an application is submitted, processing, underwriting, inspections and appraisals may all need to be done prior to the loan closing. These steps may be performed by different people and coordinating their efforts may be difficult and may cause delays. As delays occur, certain consequences and/or penalties may be triggered. These consequences and penalties may lead to an increase in network traffic as users 112 attempt to remedy the delays, consequences, and/or penalties rather than push the loan towards closing.

Processing module 110 may facilitate the coordination effort and may reduce delays thereby reducing the amount of network traffic over network 120. For example, processing module 110 may analyze information associated with previous loans to estimate the closing date of a requested loan. Furthermore, processing module 110 may analyze information associated with previous loans in order to schedule tasks that need to be completed in order for a requested loan to close by a particular date. Processing module 110 may further store and/or maintain documents associated with a requested loan so that documents associated with the requested loan may be maintained in a centralized location. Moreover, processing module 110 may notify different users 112 regarding a schedule of tasks. For example, if the next scheduled task is an inspection, processing module 110 may notify an inspector to begin the inspection and to complete it by a certain date. In this manner, processing module 110 may reduce the amount of traffic over network 120 associated with remedying delays in the process.

FIG. 8 illustrates system 100 of FIG. 1 determining an order of operation. As provided by FIG. 8, processing module 110 may receive a loan request 880. Processing module 110 may analyze loan information 810 to determine a set of dates associated with the requested loan. Processing module 110 may then send messages 820 and 830 in order to notify various users 112 of these dates. Processing module 110 may store and/or maintain documents 840 associated with loan request 880.

Processing module 110 may receive loan request 880. Loan request 880 may include information associated with a requested loan. For example, loan request 880 may include borrower information, lender information, currency, borrower country, lender country, and closing date. Processing module 110 may use the information in loan request 880 to determine a schedule of events so that the requested loan may close on time. For example, processing module 110 may determine a schedule of events so that the requested loan may close by a required closing date.

Processing module 110 may analyze stored loan information 810 to determine a schedule of events associated with the requested loan. Loan information 810 may include information associated with the requested loan and information associated with previous loans. For example, loan information 810 may include borrower information, lender information, borrower country, lender country, interest rate, and closing date for the requested loan and for the previous loan. Loan information 810 may also include the date on which information associated with the requested loan and the previous loans was generated. Loan information 810 may further include dates that certain tasks associated with the previous loan were completed. For example, loan information 810 may include the dates that appraisals and inspections were completed for the previous loan. Processing module 110 may analyze loan information 810 associated with one or more previous loans in order to determine a schedule of events for the requested loan. For example, processing module 110 may analyze the number of days to close for the previous loans in order to estimate the number of days to close for the requested loan. Processing module 110 may further analyze the number of days it took to complete particular tasks for the previous loans in order to determine the schedule of tasks for the requested loan. For example, processing module 110 may determine that on average inspections for previous loans took five days. As a result, processing module 110 may schedule an inspection to occur at least five days before the required closing date of the requested loan.

Processing module 110 may also estimate a closing date for the requested loan based on the number of days it took to close previous loans. For example, if previous loans, on average, took thirty days to close, then processing module 110 may estimate that the requested loan will take thirty days to close.

Processing module 110 may communicate a message 820 indicating the schedule of events for the requested loan. Message 820 may include the beginning date for the loan, such as the date on which a letter of intent was received and/or the date on which information associated with the requested loan was generated in processing module 110, and the names of the events and the date by which the event should be completed in order for the loan to close by an estimated closing date and/or a required closing date. Message 820 may also indicate the order that the events should take place. Furthermore, message 820 may indicate the user 112 who is assigned to complete each task. After device 114, such as a mobile device, receives message 820, device 114 may present a timeline representing the schedule of events in message 820. In the illustrated example, device 114 presents a timeline indicating that a letter of intent should be received by May 13th and appraisal should take place by July 15th and inspection should occur by August 5th and the loan should close by August 13th. This disclosure contemplates message 820 including any appropriate date for any appropriate event associated with the requested loan.

When a task has begun, user 112 who started the task may send a message to processing module 110 to alert processing module 110 that the task has begun. When a task is complete, user 112 who completed the task may send a message to processing module 110 to alert the processing module 110 that the task is completed. Processing module 110 may further communicate to other users 112 that particular tasks have begun and/or completed in order to reduce delays associated with the loan process.

Processing module 110 may further communicate a message 830 in order to alert a user 112 of a particular event associated with the requested loan. For example, if user 112 is assigned to perform a task associated with the requested loan, message 830 may notify user 112 when it is time to begin working on the task and/or that the task should be completed by a certain date in order for the loan to close by an estimated closing date and/or a required closing date. Using the illustrated example, if user 112 is the inspector, then message 830 may notify user 112 to begin the inspection when the appraisal has been completed and to complete the inspection by August 5th. Processing module 110 may have been alerted by the appraiser when the appraisal was completed. In particular embodiments, message 830 may indicate delays associated with the requested loan. For example, if the loan is required to close by a certain date but the estimated date of closing is later than the required date, message 830 may notify user 112 that the loan may not close on time.

Processing module 110 may receive a message 850 notifying the processing module 110 that a task has begun or has been completed. Message 850 may include information associated with the task such as the name of the task, the date the task began, or the date the task completed. Message 850 may further include information associated with user 112 that performed the task. After processing module 110 receives message 850, processing module 110 may update the schedule of events associated with the requested loan. For example, if message 850 indicates that an appraisal was completed three days late. Processing module 110 may update the schedule for events occurring after the appraisal. Furthermore, processing module 110 may also update the estimated closing date for the requested loan. Processing module 110 may communicate messages 820 and 830 in response to any updates occurring as a result of message 850.

Processing module 110 may store and maintain documents 840 associated with the requested loan. For example, processing module 110 may maintain a letter of intent, appraisal documents, inspection reports, and/or closing documents associated with the requested loan. This disclosure contemplates processing module 110 storing and maintaining any appropriate documents associated with the requested loan. Users 112 may then view, modify, update, and/or delete documents 840 from the processing module 110. This disclosure contemplates users 112 taking any appropriate action on a document 840. In this manner, processing module 110 may track and maintain documents 840 associated with the requested loan in a centralized location. Users 112 may then access these documents 840 when the documents 840 are needed. As an example and not by way of limitation, the inspector that performed the inspection associated with the requested loan may upload his inspector's report onto processing module 110. Subsequently, a loan officer may retrieve and view the inspector's report from processing module 110 without having to request the inspector's report from the inspector. In this manner, processing module 110 may reduce delays thereby reducing the amount of traffic over network 120.

In particular embodiments, processing module 110 may maintain confidentiality for particular tasks. For example, processing module 110 may receive and/or store a confidentiality policy that indicates that appraisals should only be visible to user 112. As a result, processing module 110 may present the appraisal task to only device 114 associated with user 112. Furthermore, processing module 110 may prevent others besides user 112 from viewing appraisal documents. This disclosure contemplates processing module 110 maintaining confidentiality of any appropriate information in any appropriate manner.

In particular embodiments, processing module 110 may request confirmation of particular tasks and/or events. For example, prior to communicating message 820 that includes the schedule of events, processing module 110 may request confirmation from an administrator that the schedule of events is accurate. After receiving confirmation, processing module 110 may communicate message 820 to the appropriate recipients. As another example, processing module 110 may request confirmation from user 112 when particular tasks are completed. In this manner, user 112 may confirm and/or approve a particular task, such as an appraisal, prior to processing module 110 communicating message 830 to provide notification that the next task should begin.

Although this disclosure describes processing module 110 performing certain actions with respect to FIG. 8, this disclosure contemplates processor 132, memory 134, and network interface 136 of processing module 110 performing these actions. The illustration of system 100 and FIG. 8 does not specifically illustrate all of the elements from the illustration of system 100 in FIG. 1 so that particular aspects of system 100 may be emphasized. However, system 100 of FIG. 8 includes all the elements of system 100 in FIG. 1.

FIG. 9 is a flowchart illustrating a method 900 for determining orders of operation using system 100 of FIG. 1. Processing module 110 may perform method 900. Processing module 110 may begin by storing information associated with a loan and a previous loan in step 905. The information may include borrower information, lender information, borrower country, lender country, currency, estimated closing dates, actual closing dates, and dates associated with events associated with the loan and the previous loan.

In step 910, processing module 110 may determine a first date that the information associated with the loan was generated. For example, processing module 110 may determine that the first date was the date that processing module 110 received a loan request requesting the loan. As another example, processing module 110 may determine the first date to be the date that a letter of intent associated with the loan was received.

In step 915, processing module 110 may determine a second date on which the loan is estimated to close based on the first date and the information associated with the previous loan. Processing module 110 may determine that the previous loan took 30 days to close. Based on similarities between the previous loan and the loan, processing module 110 may estimate that the loan should close in 30 days. As an example, processing module 110 may determine that the borrower for the loan is similarly situated to the borrower for the previous loan. Based on this determination, processing module 110 may determine that the time to close for the loan is similar to the time to close for the previous loan.

In step 920, processing module 110 may determine a third date on which a task associated with the loan should be completed in order for the loan to close by the second date. For example, processing module 110 may determine that an inspection should occur at least ten days prior to the closing date of the loan. Processing module 110 may then set the third date to be ten days prior to the closing date of the loan.

Processing module 110 may determine a fourth date by which the loan is required to close in step 925. The required closing date may be included in a loan request associated with the loan. In step 930, server 130 may determine whether the second date is later than the fourth date. In other words, processing module 110 may determine whether the estimated closing date of the loan is later than the required closing date for the loan. If not, method 900 continues from step 940. However, if the estimated closing date is later than the required closing date, processing module 110 may indicate an alert indicating that the loan may not close on time in step 935.

In step 940, processing module 110 may determine whether the current date is later than the third date and whether the task is unfinished. In other words, processing module 110 may determine whether the task has been delayed. If not, processing module 110 may conclude. However, if the task has been delayed, processing module 110 may communicate a second alert indicating that the task is late in step 945. By communicating these alerts, processing module 110 may reduce the amount of network traffic over network 120 resulting from delays.

Modifications, additions, or omissions may be made to method 900 depicted in FIG. 9. Method 900 may include more, fewer, or other steps. For example, steps may be performed in parallel or in any suitable order. While discussed as processing module 110 performing the steps, any suitable component of system 100, such as device 114 for example, may perform one or more steps of the method.

FIGS. 10 and 11 illustrate system 100 modifying a template. In general, user 112 may use device 114 to view and/or update information regarding loans. However, the information that is presented to user 112 should be changed and/or altered based on where the user 112 is located. For example, if user 112 is located in South America, information regarding cross border license such as an EEA passport need not be presented to user 112. As a result, when processing module 110 determines that user 112 is located in South America, processing module 110 may remove information associated with a EEA passport from a template. That information will then be left off when processing module 110 populates the template. In this manner, processing module 110 may create templates and forms based on the location of user 112 thereby reducing the amount of traffic over network 120 associated with the transmittal of unnecessary or irrelevant information.

FIG. 10 illustrates system 100 of FIG. 1 modifying a template 1020. As provided by FIG. 10, processing module 110 may receive a location 1030. Based on that location 1030, processing module 110 may reference a location-based rule 1010 to determine what modifications, if any, should be made to a template 1020. If modifications should be made, processing module 110 makes the modifications and sends a modified template 1040 to device 114.

Processing module 110 may receive location 1030 from device 114. Location 1030 may indicate a location associated with device 114 and/or user 112. Location 1030 may represent the geolocation of device 114. For example, location 1030 may include a longitude and a latitude associated with the geographic location of device 114. Device 114 may have received its longitude and latitude through the global positioning system and/or radio triangulation. As another example, device 114 may have used its network location including an internet protocol (IP) address to determine its location. This disclosure contemplates using any appropriate method to determine the location of device 114.

Based on the location of device 114, processing module 110 may determine that particular information should not be presented to user 112. In particular embodiments, processing module 110 may make this determination based at least in part upon a location-based rule 1010. Location-based rule 1010 may indicate the particular types of information that should not be presented based on a provided location 1030. For example, location-based rule 1010 may indicate that cross border licensing information should not be presented when the supplied location 1030 is Japan because Japan does not require a cross border license in order to take out a loan. As another example, location-based rule 1010 may specify that particular execution requirements should be presented when the supplied location 1030 is Germany because Germany may have execution requirements that are particular to it. In particular embodiments, location-based rule 1010 may further indicate particular information that should be presented based on a supplied location 1030. For example, location-based rule 1010 may indicate that information regarding particular tax provisions should be presented if the supplied location is the United States.

In particular embodiments, processing module 110 may have generated location-based rule 1010 based on previous loans. For example, if previous loans in Canada include a currency of “Canadian dollar,” then processing module 110 may generate location-based rule 1010 that specifies that the currency for supplied locations 1030 in Canada should be “Canadian dollar.” As another example, if previous loans in Japan disregarded the EEA passport requirement, then processing module 110 may generate a location-based rule 1010 that specifies that the EEA passport field should be excluded for supplied locations 1030 in Japan.

Processing module 110 may modify a template 1020 based on location-based rule 1010. If location-based rule 1010 indicates that particular information should not be presented, processing module 110 may remove fields from the template 1020 representing that information. If location-based rule 1010 indicates that particular information should be added to the template 1020, processing module 110 may add fields representing that information to template 1020. For example, if location-based rule 1010 indicates that information associated with a particular tax provision need not be presented, processing module 110 may remove fields associated with that tax provision from the template 1020. In the alternative, if location-based rule 1010 indicates that information associated with that tax provision should be presented, processing module 110 may add fields associated with that tax provision in template 1020.

In particular embodiments, processing module 110 may populate files of template 1020 based upon the location-based rule and supplied location 1030. For example, if supplied location 1030 is Canada, processing module 110 may populate the country field as “Canada” based on the supplied location 1030. Furthermore, processing module 110 may populate the tax withholding field with a Canadian national rate and the currency field with “Canadian dollar” based on a location-based rule.

Location-based rule 1010 may indicate how information should be stated and/or presented in order to observe cultural and linguistic norms of a supplied location 1030 in particular embodiments. As an example, for a supplied location 1030 of China, location-based rule 1010 may specify that a particular word should not be used because people from China find that word offensive. As a result, processing module 110 may modify template 1020 in order to avoid using that word. As another example, processing module 110 may populate fields using the language of the supplied location 1030. For a supplied location 1030 of Brazil, processing module 110 may populate the fields using Portuguese. As another example, if supplied location 1030 is Japan, processing module 110 may populate the fields using Japanese.

After modifying template 1020, processing module 110 may send a modified template 1040 to user 112. Modified template 1040 may include and exclude certain fields based on location-based rule 1010. As an example, if user 112 is in South America, location-based rule 1010 may indicate that information regarding a particular tax provision should not be presented to user 112. As a result, modified template 1040 may not include fields associated with that tax provision. In this manner, processing module 110 reduces the amount of traffic over network 120 associated with the transmittal of unnecessary or irrelevant information.

Although this disclosure describes processing module 110 performing certain actions with respect to FIG. 10, this disclosure contemplates processor 132, memory 134, and network interface 136 of processing module 110 performing these actions. The illustration of system 100 in FIG. 10 does not specifically illustrate all of the elements from the illustration of system 100 in FIG. 1 so that particular aspects of system 100 may be emphasized. However, system 100 of FIG. 10 includes all the elements of system 100 in FIG. 1.

FIG. 11 is a flowchart illustrating a method 1100 for modifying templates using the system 100 of FIG. 1. Processing module 110 may perform method 1100. Processing module 110 may begin by storing a location-based rule and a template in step 1105. The location-based rule may indicate particular information that should be removed and added based on the location supplied by a user. The template may include fields associated with particular types of information. For example, the template may include fields for tax provisions, cross border licenses, and contact information. This disclosure contemplates template including any appropriate information associated with a loan.

In step 1110, processing module 110 may receive a location associated with a user. The location may be the geolocation of the user. The location may have been determined using the global positioning system and/or radio triangulation. In particular embodiments, the location may include an IP address of the user.

In step 1115, processing module 110 determines whether the location-based rule applies to the location. For example, the location may include an IP address associated with South America. Processing module 110 may examine the internet protocol address and determine that the user is located in South America. Processing module 110 may then examine the location-based rule to see whether the location-based rule applies to South America. If it does not, processing module 110 may conclude at step 1140 by communicating the template to the user.

If the location-based rule does apply to the location, method 1100 continues from step 1120 and processing module 110 determines whether a field should be added to the template based on the location-based rule. Using the previous example, the location-based rule may indicate that if the location is South America fields associated with a particular tax provision should be added to the template. Processing module 110 may add these fields in step 1125.

After the fields have been added or if no fields were to be added, processing module 110 may continue to step 1130 to determine if a second field should be removed from the template based on the location-based rule. Using the previous example, the location-based rule may indicate that fields associated with cross border licenses should be removed from the template if the location is South America. As a result, processing module 110 will remove those fields from the template in step 1135.

After the template has been modified according to the location-based rule, processing module 110 may communicate the template to the user in step 1140. The template should include information that is relevant to the location of the user and it should exclude information that is not relevant to the location of the user. In this manner, processing module 110 may reduce the amount of traffic over network 120 associated with the transmittal of unnecessary or irrelevant information.

Modifications, additions, or omissions may be made to method 1100 depicted in FIG. 11. Method 1100 may include more, fewer, or other steps. For example, steps may be performed in parallel or in any suitable order. While discussed as processing module 110 performing the steps, any suitable component of system 100, such as device 114 for example, may perform one or more steps of the method.

FIGS. 12 and 13 illustrate system 100 determining an offer. In general, when a lender cannot fully fund a loan because of insufficient funds or because the loan amount presents an unacceptable level of risk to the lender, the lender may offer a portion of the loan amount to be funded by another lender. The process of identifying and making offers and subsequent offers to other lenders may result in delays in funding the loan. Consequences and penalties associated with the delays may result in increased traffic over network 120.

Processing module 110 may facilitate the process of identifying and making offers and subsequent offers to other lenders in order to reduce delays and the traffic over network 120. User 112 may provide processing module 110 with a list or a set of other lenders that user 112 wants to offer to fund a portion of a loan. Processing module 110 may then make offers to these other lenders. Processing module 110 may implement other features such as timeouts and alerts in order to aid this process.

FIG. 12 illustrates system 100 of FIG. 1 determining an offer 1290. As provided by FIG. 12, processing module 110 may receive a loan request 1280 associated with a loan that user 112 cannot or does not wish to fully fund. Processing module 110 may examine stored lender information 1210 and receive a lender selection 1285. Based on lender information 1210 and lender selection 1285, processing module 110 may determine a lender 1220 or a set of lenders 1220 to whom an offer 1290 should be made.

Processing module 110 may receive loan request 1280 associated with a loan. The loan request 1280 may indicate a portion of the loan amount to be funded by another lender or other lenders. As an example, user 112 may be a lender who does not wish to fully fund a loan. User 112 may send loan request 1280 to processing module 110 indicating that user 112 is willing to offer 30 percent of the loan amount to other lenders. Loan request 1280 would indicate the loan amount and the percentage to be offered to other lenders. In particular embodiments, loan request 1280 may further indicate a timeout by which the other lenders should accept or reject the offer. If the other lenders do not accept the offer before the timeout expires, then the offer will be considered rejected.

User 112 may further send a lender selection 1285 to processing module 110. Lender selection 1285 may include a lender or a set of lenders to whom the user 112 wishes to make offers. In particular embodiments, lender selection 1285 may further include a lender or a set of lenders to whom user 112 does not wish to make an offer. As an example, processing module 110 may present user 112 with a list of potential lenders. User 112 may select from that list, lenders to whom offers should be made and lenders to whom offers should not be made. After making his selections, device 114 may communicate lender selection 1285 to processing module 110. Processing module 110 may further store the lender selection 1285 as a preference of user 112 under a profile associated with the user 112. For subsequent loans, processing module 110 may use a stored preference to determine set of lenders 1220 to whom offers to fund a portion of the loan should be made. As an example, user 112 may select lender B to fund a portion of the loan and processing module 110 may store that preference. User 112 may further instruct processing module 110 to store lender C as a preference, and processing module 110 will store lender C as a preference. On a later loan, user 112 may instruct processing module 110 to make offers to his preferred lenders. In response, processing module 110 may send offers 1290 to lenders B and C to fund a portion of the later loan. Processing module 110 may also generate for user 112 a list of preferred lenders that includes lenders B and C based on user's 112 stored preference.

After receiving lender selection 1285, processing module 110 may reference lender information 1210 in order to communicate offers 1290 to a selected lender 1220. Lender information 1220 may include contact information such as name, address, phone number, and/or an email address. Based on lender information 1210, processing module 110 may communicate offer 1290 to selected lender 1220. Offer 1290 may include information associated with the loan such as, for example, borrower information, the interest rate, loan amount, currency, and the portion of the loan amount to be funded by lender 1220. Offer 1290 may also include a hyperlink through which lender 1220 may accept the offer 1290. As an example, if user 112 has indicated that lender 1220 should be offered 20 percent of the loan, processing module 110 may communicate offer 1290 to lender 1220 indicating that user 112 wants lender 1220 to fund 20 percent of the loan. Offer 1290 may also include a link that lender 1220 can click to accept the offer 1290. If lender 1220 clicks a link, then lender 1220 will have accepted the offer. Processing module 110 may then communicate a notification back to user 112 to indicate that lender 1220 has accepted the offer.

In particular embodiments, offer 1290 may include a timeout. The timeout may have been indicated by user 112 in loan request 1280. The timeout may indicate to lender 1220 how much time he has to accept the offer 1290 before the offer 1290 is considered rejected. In particular embodiments, user 112 may indicate a secondary group of lenders 1220 in loan request 1280. If offer 1290 is not accepted by lender 1220 before the expiration of the timeout, or if lender 1220 rejects the offer of 1290, then processing module 110 may communicate a second group of offers 1290 to the secondary group of lenders 1220. The second group of offers 1290 may include the loan information and/or timeouts. As an example, if lender 1220 fails to accept the offer 1290 prior to the expiration of the timeout, processing module 110 may generate a second group of offers 1290 to a second group of lenders 1220 indicated by user 112. The second group of offers 1290 may include different terms than the original offer 1290. For example, the second group of offers 1290 may include a higher interest rate and/or lower percentages of the loan amount to be funded by the second group of lenders. In this manner, processing module 110 may reduce the amount of traffic over network 120 associated with user 112 generating individual offers to individual lenders 1220.

Processing module 110 may communicate an alert to lender 1220 prior to the timeout expiring. The alert may indicate to lender 1220 that the timeout is about to expire and that upon expiration, lender 1220's non-response will be considered a rejection of the offer. In this manner, processing module 110 may assist in securing more acceptances of offers 1290.

Although this disclosure describes processing module 110 performing certain actions with respect to FIG. 12, this disclosure contemplates processor 132, memory 134, and network interface 136 of processing module 110 performing these actions. The illustration of system 100 in FIG. 12 does not specifically illustrate all of the elements from the illustration of system 100 in FIG. 1 so that particular aspects of system 100 may be emphasized. However, system 100 of FIG. 12 includes all the elements of system 100 in FIG. 1.

FIG. 13 is a flowchart illustrating a method 1300 for determining offers. Processing module 110 may perform method 1300. In step 1305, server 100 may begin by storing information about a lender. The information may include the lender's name, address, phone number, email, and any other appropriate information sufficient to contact the lender.

In step 1310, server 100 may receive a loan request associated with a loan. The loan request may include any appropriate information associated with the loan such as borrower information, interest rate, and loan amount. The loan request may further include the percentage of the loan amount to be funded by another lender. For example, a user 112 may indicate that 20 percent of the loan should be funded by another lender.

Processing module 110 may receive a lender selection in step 1315. The lender selection may include a selection of lenders to whom a portion of the loan should be offered and a selection of lenders to whom the portion of the loan should not be offered. User 112 may have selected these lenders and the selection may be stored by processing module 110.

In step 1320, processing module 110 may determine whether the loan has been fully funded. If the loan has been fully funded, processing module 110 may conclude. If the loan has not been fully funded, method 1300 continues from step 1325 and processing module 110 determines an offer to a selected lender to fund a portion of the loan. As an example, if the loan request indicates that 20 percent of the loan should be funded by another lender and the lender selection indicates a particular lender, then processing module 110 may determine an offer to the particular lender to fund 20 percent of the loan. Then in step 1330, processing module 110 may communicate the offer to the particular lender. The lender may then accept or reject the offer.

Modifications, additions, or omissions may be made to method 1300 depicted in FIG. 13. Method 1300 may include more, fewer, or other steps. For example, steps may be performed in parallel or in any suitable order. While discussed as processing module 110 performing the steps, any suitable component of system 100, such as device 114 for example, may perform one or more steps of the method.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An apparatus comprising:
a memory operable to store contact information associated with a plurality of lenders;
a network interface operable to:
receive a request for a loan, wherein a portion of the loan is to be funded by a first lender; and
receive a second request indicating a second lender selected from the plurality of lenders; and
a processor communicatively coupled to the memory and to the network interface and operable to determine an offer for a second portion of the loan to be funded by the second lender;
wherein:
the network interface is further operable to communicate the offer based at least in part upon the contact information associated with the second lender; and
the second portion is not funded by the first lender.

2. The apparatus of claim 1, wherein:
the memory is further operable to store a preference; and
the processor is further operable to:
select, based at least in part upon the preference, a third lender; and
determine a second offer for a third portion of the loan to be funded by the third lender; and
the network interface is further operable to communicate the second offer, wherein the third portion is not funded by the first lender and the second lender.

3. The apparatus of claim 2, wherein the processor is further operable to generate a list of lenders from the plurality of lenders based at least in part upon the preference.

4. The apparatus of claim 1, wherein:
the offer indicates a timeout; and
the processor is further operable to determine a second offer for the second portion of the loan to be funded by a third lender selected from the plurality of lenders after the timeout has expired.

5. The apparatus of claim 4, wherein the network interface is further operable to communicate, prior to the timeout expiring, an alert indicating that the timeout will expire.

6. The apparatus of claim 1, wherein the offer indicates a currency and a borrower associated with the loan.

7. The apparatus of claim 1, wherein the offer comprises a hyperlink that can be accessed to indicate acceptance of the offer.

8. A method comprising:
storing contact information associated with a plurality of lenders;
receiving a request for a loan, wherein a portion of the loan is to be funded by a first lender;
receiving a second request indicating a second lender selected from the plurality of lenders;
determining an offer for a second portion of the loan to be funded by the second lender; and
communicating the offer based at least in part upon the contact information associated with the second lender;
wherein the second portion is not funded by the first lender.

9. The method of claim 8, further comprising:
storing a preference;
selecting, based at least in part upon the preference, a third lender;
determining a second offer for a third portion of the loan to be funded by the third lender; and
communicating the second offer, wherein the third portion is not funded by the first lender and the second lender.

10. The method of claim 9, further comprising generating a list of lenders from the plurality of lenders based at least in part upon the preference.

11. The method of claim 8, wherein:
the offer indicates a timeout; and
the method further comprises the step of determining a second offer for the second portion of the loan to be funded by a third lender selected from the plurality of lenders after the timeout has expired.

12. The method of claim 11, further comprising the step of communicating, prior to the timeout expiring, an alert indicating that the timeout will expire.

13. The method of claim 8, wherein the offer indicates a currency and a borrower associated with the loan.

14. The method of claim 8, wherein the offer comprises a hyperlink that can be accessed to indicate acceptance of the offer.

15. A system comprising:
a storage element operable to store contact information associated with a plurality of lenders;
a communication element operable to:
receive a request for a loan, wherein a portion of the loan is to be funded by a first lender; and
receive a second request indicating a second lender selected from the plurality of lenders; and
a processing element communicatively coupled to the memory and to the network interface and operable to determine an offer for a second portion of the loan to be funded by the second lender;
wherein:
the communication element is further operable to communicate the offer based at least in part upon the contact information associated with the second lender; and
the second portion is not funded by the first lender.

16. The system of claim 15, wherein:
the storage element is further operable to store a preference; and
the processing element is further operable to:
select, based at least in part upon the preference, a third lender; and
determine a second offer for a third portion of the loan to be funded by the third lender; and
the communication element is further operable to communicate the second offer, wherein the third portion is not funded by the first lender and the second lender.

17. The system of claim 16, wherein the processing element is further operable to generate a list of lenders from the plurality of lenders based at least in part upon the preference.

18. The system of claim 15, wherein:
the offer indicates a timeout; and
the processing element is further operable to determine a second offer for the second portion of the loan to be funded by a third lender selected from the plurality of lenders after the timeout has expired.

19. The system of claim 18, wherein the communication element is further operable to communicate, prior to the timeout expiring, an alert indicating that the timeout will expire.

20. The system of claim 15, wherein the offer indicates a currency and a borrower associated with the loan.

21. The system of claim 15, wherein the offer comprises a hyperlink that can be accessed to indicate acceptance of the offer.
